(19) United States
(12) Patent Application Publication
(10) Pub. No.: US 2026/0302103 A1
(43) Pub. Date: Oct. 1, 2026

(54) KEY STRUCTURE

(71) Applicants: Logitech Europe S.A., Lausanne (CH); Logitech Technology (Suzhou) Company Limited, Suzhou New District (CN)

(72) Inventor: Youxin ZHAN, Xiamen City (FJ)

(21) Appl. No.: 19/100,873

(22) PCT Filed: Jan. 16, 2024
(86) PCT No.: PCT/CN2024/072608

§ 371 Date: Feb. 3, 2025

(30) Foreign Application Priority Data
Jan. 16, 2023 (CN) 202320143511.3

(51) Int. Cl. H01H 13/83; H01H 13/703; H01H 13/7065; H01H 13/85

(52) U.S. Cl. CPC H01H 13/83; H01H 13/703; H01H 13/7065; H01H 13/85; H01H 2219/036; H01H 2221/044; H01H 2223/036; H01H 2229/038

(57) ABSTRACT

Embodiments of the disclosure include a key structure, comprising a top shell, keys, an elastic component, a detection module, and a display module. The elastic component is placed under the top shell, which features multiple holes for keys. Each hole contains a key situated on the elastic component. Below the elastic component is a detection module that senses actions of the keys. Guide ribs are placed on the lower surface of the top shell at the edges of the holes, and the edges of the keys have guide grooves for engagement with the guide ribs, which serve to limit X and Y directional wobble when the keys are pressed and thus enhancing the tactile feel when pressing the keys.

### CROSS-REFERENCE TO RELATED APPLICATIONS

This application is a National Phase Application of PCT Application, serial Number PCT/CN2024/072608, filed Jan. 16, 2024, which claims the benefit of Chinese application serial number 202320143511.3, filed Jan. 16, 2023, which is herein incorporated by reference.

### TECHNICAL FIELD

Embodiments of the disclosure provided herein relate to the technical field of electronic equipment, particularly to a key structure.

### BACKGROUND ART

Currently, the market offers transparent keyboards where the screen design reflects images directly onto the transparent keys. The keys are held in place by a frame and an elastic support part, with a protruding part transferring the key action to a detection module, achieving the function of key action and screen display. When the body of the key is pressed down to the screen below, the elastic support moves the protruding part against the detection module, executing a command displayed on the screen. Once the action is completed, the protruding part and the detection module are separated by the elastic support part, ready for the next press command. However, the aforementioned key structure has the following issues that need improvement: referring to the Chinese utility model patent with the publication number CN204424130U and entitled Key Structure, as shown in FIG. 1, a transparent keyboard currently on the market lacks guiding structures in its keys 1 and elastic support part 3, leading to no limit on the movement of the keys in the X and Y directions. This results in the keys being prone to tilting at their edges, severe wobbling during pressing, and an overall poor tactile sensation.

### SUMMARY

To solve the aforementioned problems, one or more of the objectives of this disclosure is to disclose a key structure that employs guide grooves and guide ribs in the keys and a top shell to limit the tilt and lateral movement of the keys in the X and Y directions.

Aspects of the disclosure are realized through the following components: a key structure that includes a top shell, keys, an elastic component, a detection module, and a display module. The elastic component is located beneath the top shell, which has multiple holes for the keys. Each hole contains a key positioned on the elastic component, and below this is a detection module that senses key actions. The guide ribs are positioned on the lower surface of the top shell at the edges of the holes, and the edges of the keys have corresponding guide grooves for engagement with the guide ribs, which is used to limit wobbling or lateral movement in the X and Y directions when the keys are pressed.

In one embodiment, the positions at the edges of the bottom surfaces of the keys, which avoid the guide grooves, are equipped with pressing protrusions. The detection module is provided with multiple receptors that correspond to these pressing protrusions on the keys.

In one embodiment, the detection module is composed of a single-layer thin film, which is divided into a left part and a right part. A folding line is set at the junction of the left and right parts of the film. The right part of the film folds over the right part along this line, with a double-sided tape placed between them for separation, thus forming film switches that correspond to the number and locations of the keys.

In one embodiment, at least one guide rib is set near the edge of each of the four sides of every hole on the lower surface of the top shell, and a corresponding number of guide grooves are created on corresponding positions of corresponding side edges of the corresponding keys.

The beneficial effects of the embodiments of this disclosure include: a key structure that, compared with existing technology, has at least the following technical effects: guiding and limiting the movement of the keys when the keys are pressed through the use of guide ribs and grooves, specifically through guide ribs on the top shell and guide grooves on the edges of the keys for precise guidance, thereby preventing wobble in the X and Y directions and thus enhancing the tactile feel of key presses. Compared with existing key structures where pressing protrusions provided on the elastic component 3 which are elastic protrusion 4 (as shown in FIG. 2) result in large compression and uneven force distribution, further leading to instability, this design eliminates pressing protrusions on the elastic component. Instead, the triggering pressing protrusions of the film are placed on the non-elastic bottom surfaces of the keys, which are nearly non-elastic and compression-free, stabilizing key travel. Compared with the existing technology in which a keyboard film with a three-layer PET film structure of a detection module 5 is assembled by bonding to form film switches (as shown in FIG. 3), where aligning each film layer is challenging and it is easy to cause triggering issues, this design can include a single layer and achieves the same switch functionality by folding and separating with a double-sided tape added in the middle. The structure is greatly simplified, and allows for rapid and precise alignment through folding to form a multi-layer film switch structure, which can significantly lower production costs and improve manufacturing efficiency.

Embodiments of the disclosure include a key structure, comprising: a top shell comprising a plurality of holes and a plurality of guide ribs, wherein one or more guide ribs are positioned at two or more edges of each of the holes; a plurality of keys; a detection module comprising a plurality of conductive contact structures; and a display module. Each of the keys comprise: a key body; one or more protrusions extending from a surface of the key body; and a plurality of guide grooves formed in the key body. The detection module is disposed between the display module and the plurality of keys. A key of the plurality of keys is positioned within each of the holes of the top shell. Each key is positioned over a conductive contact structure of the detection module. The one or more protrusions of each key is positioned over a corresponding conductive contact structure, and each guide rib is disposed within a corresponding guide groove of each key of the plurality of keys.

Embodiments of the disclosure include a key structure, comprising: a top shell comprising a plurality of holes and a plurality of guide ribs, wherein one or more guide ribs are positioned at two or more edges of each of the holes; a plurality of keys; a detection module comprising a plurality of conductive contact structures; and a display module. Each of the keys comprise: a key body; one or more protrusions extending from a surface of the key body; and a plurality of guide ribs. The detection module is disposed between the display module and the plurality of keys. A key of the plurality of keys is positioned within each of the holes of the top shell. Each key is positioned over a conductive contact structure of the detection module. The one or more protrusions of each key is positioned over a corresponding conductive contact structure. Each guide rib of the key body of each key is disposed within a corresponding guide groove.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a schematic diagram of the structure according to existing technology.

FIG. 2 is another schematic diagram of a structure according to existing technology.

FIG. 3 is a schematic diagram of the detection module structure according to existing technology.

FIG. 4 depicts a schematic structural diagram of disassembled components of a key structure according to one or more embodiments of the disclosure.

FIG. 5 shows a schematic diagram illustrating the connection relationship between the keys and the top shell in the key structure according to one or more embodiments of the disclosure.

FIG. 6 provides a partial enlarged schematic diagram of FIG. 5.

FIG. 7 illustrates a schematic structural diagram of disassembled components of the keys and the top shell in the key structure according to one or more embodiments of the disclosure.

FIG. 8 presents a partial enlarged schematic structural diagram of the key part in the key structure according to one or more embodiments of the disclosure.

FIG. 9 depicts a schematic diagram of the thin film structure of the detection module in the key structure according to one or more embodiments of the disclosure.

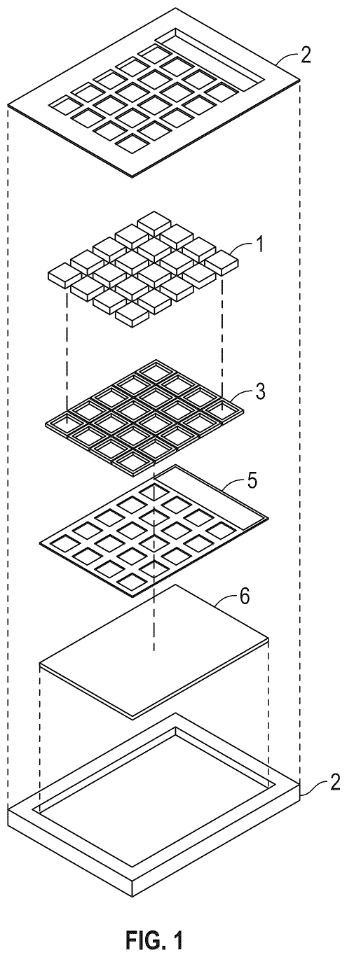

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

One or more embodiments of the disclosure are explained below, in conjunction with the accompanying drawings and related description of specific embodiments.

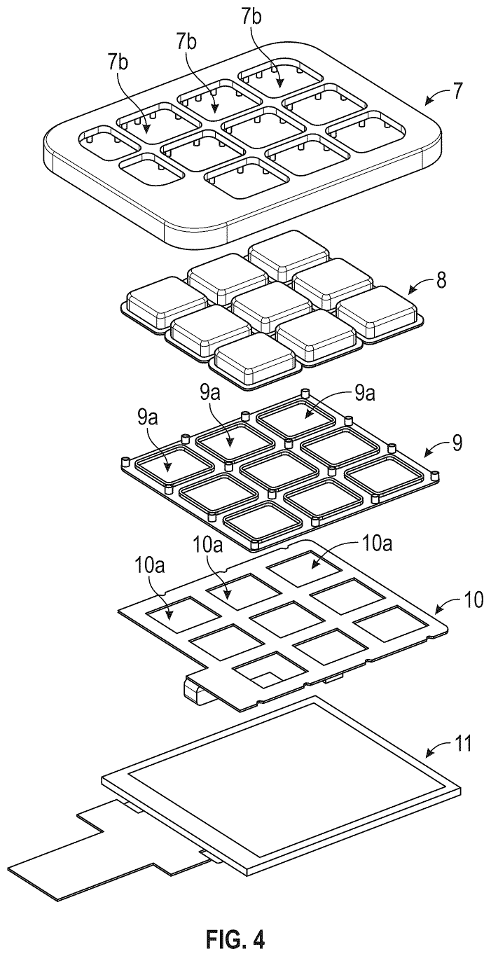

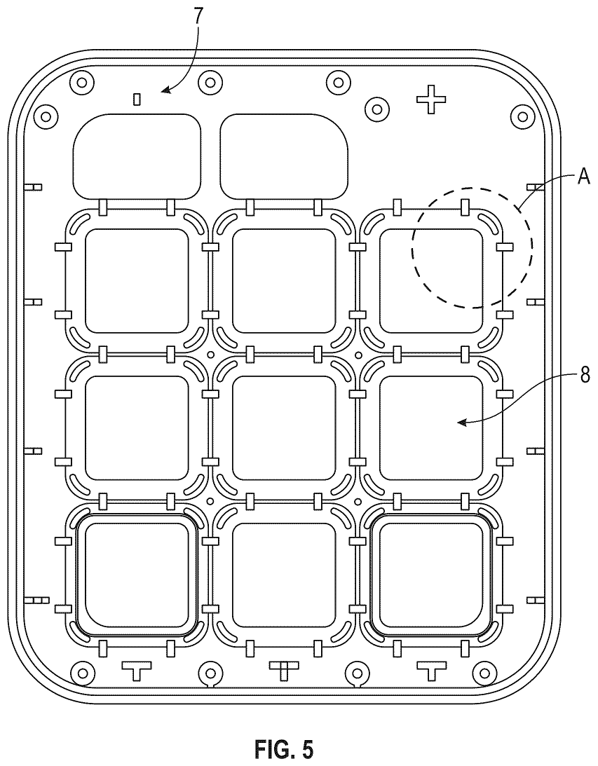

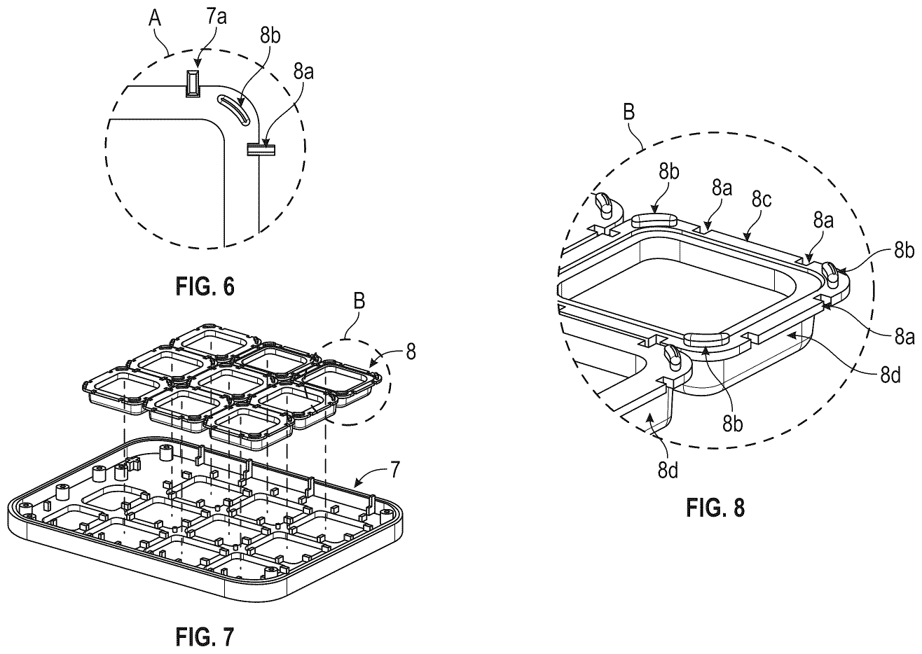

Referring to FIGS. 4 to 9 and detail A illustrated in FIGS. 5 and 6, a key structure comprises a top shell (7), keys (8), an elastic component (9), and a detection module (10). The elastic component (9) is placed beneath the top shell (7), which has multiple holes for keys. Each hole contains a key (8) situated on the elastic component (9). The elastic component (9) includes an elastomeric material layer that includes a plurality of openings (9a) formed therein. Below the elastic component (9) is a detection module (10) that senses actions of the keys (8). The detection module (10) includes a single-layer thin film (101) that includes a plurality of openings (10a) formed therein. Guide ribs (7a) are positioned on the lower surface of the top shell (7) at the edges of the holes (7b). One or more guide ribs (7a) are positioned at two or more edges of each of the holes (7b). In one example, as illustrated in FIGS. 5 and 6, two guide ribs (7a) are positioned at each of the four edges of each of the holes (7b) formed in the top shell (7). As illustrated in FIG. 6, in some embodiments, the guide ribs (7a) can be positioned at each of the corners of the holes (7b) formed in the top shell (7). The edges of a key body (8d) of the keys (8) have corresponding guide grooves (8a) for engagement with these guide ribs (7a), which limit X and Y directional movement when the keys (8) are pressed. Alternatively, the guide ribs (7a) can also be placed on the key body (8d) of the keys (8), with the guide grooves (8a) on the lower surface of the top shell (7) at the edges of the holes (7b). Through the longitudinally placed guide grooves (8a) and the engagement with the guide ribs (7a) that are engaged with the guide grooves (8a) for movement limitation, precise guidance in the longitudinal Z-axis direction is achieved, which restricts the offset in the X and Y directions when the keys (8) are pressed, thus preventing wobble of the keys (8) and enhancing the tactile feel when the keys (8) are pressed.

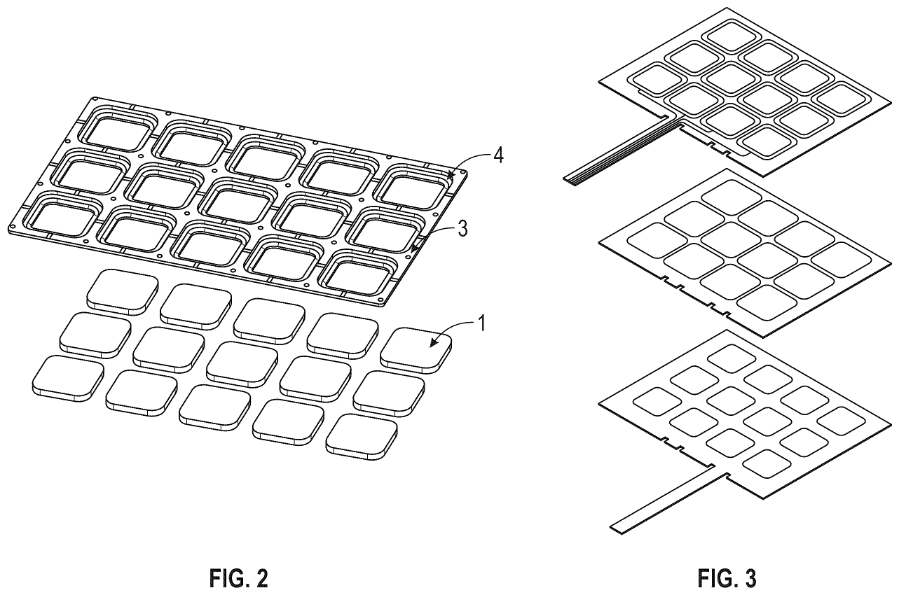

Referring to FIG. 2, and 4-9 and detail B illustrated in FIGS. 7 and 8, in one embodiment, the bottom surface (8c) of the key body (8d) of the key (8) is designed with a pressing protrusion (8b) at a position that avoids the guide grooves (8a). The detection module (10) is equipped with multiple receptors corresponding to these pressing protrusions (8b) on the keys (8). Instead of placing protrusions on the elastic component (9), the pressing protrusions (8b) are positioned on the non-elastic underside (e.g., bottom surface 8c) of the key (8). The protrusions (8b) on the key (8) have almost no elasticity or compression, further enhancing the stability of the travel of the key (8) and interaction with the detection module (10). In some embodiments, the pressing protrusions (8b) are formed of the same material as the keys (8). In one example, the keys are formed of a thermoplastic or a thermoset material. In some additional examples, the keys are formed of a glass material, silicone material, and/or a ceramic material. In some other embodiments, the pressing protrusions (8b) are formed a different material than the material used to form the keys (8). In one example, the pressing protrusions (8b) are formed on bottom surface (8c) of the keys (8) by use of an over-molding process or the pressing protrusions (8b), which may be formed of metal, ceramic or plastic material, are inserted or pressed into the bottom surface (8c) of the keys (8).

Referring to FIG. 4, in one embodiment, the display module (11) is positioned beneath the detection module (10). The keys (8) include a key body (8d) that is made of a translucent material, allowing images displayed by the display module (11) to be seen through the keys (8). Users can directly see the bottommost display screen of the display module (11) through the translucent material of the key bodies (8d) of the keys (8). Moreover, since all components between the key bodies (8d) of the keys (8) and the display screen of the display module (11) are designed to be hollow (e.g., the elastic component (9) and detection module (10) include openings 9a and 10a, respectively), the visibility of the display screen is preserved without affecting the completeness of the displayed images. Additionally, since the display screen is placed at the bottommost layer, it will not be damaged due to prolonged use or unstable supports. The specific principle is detailed in CN204424130U utility model application, which is incorporated by reference herein. In some embodiments, the display module (11) includes a TFT, LCD, OLED or Matrix LED module.

Referring to FIGS. 4 to 9, in one embodiment, the detection module (10) consists of a single-layer thin film (101). In some embodiments, the single-layer thin film (101) includes a plurality of openings (10a) that are surrounded by conductive contact structures (111), which are used to form part of a plurality of film switches. The film (101) is divided into a left part 106 and a right part 107, with a folding line (102) at the junction of these parts of the film (101). Positioning holes (103) are placed at the folding line on the film (101) for accurate folding, resulting in a horizontally symmetrically structured detection module (10). The right part (107) of the film (101) folds over the left part (106) along the folding line (102), and is separated by a material layer (not shown), such as a double-sided tape layer, provided therebetween, forming film switches that correspond to the number and positions of the keys (8), that is, the keys are pressed to trigger corresponding receptors of the film switches by pressing the protrusions (8b). The materials layer, such as the double-sided tape layer, is disposed in the gaps (112) formed between the conductive contact structures (111) and openings (10a). Compared with existing detection modules composed of a three-layer PET film (as shown in FIG. 3), this design of the film switch of the detection module (10) has a single-layer structure folded to form multiple layers, with a double-sided tape layer added between the folded single-layer PET film to achieve the same switch functionality. Accurate folding ensures correct assembly alignment of the opposingly positioned conductive contact structures (111) and openings (10a). Compared with the existing practice of layer-by-layer alignment and bonding, this method is quicker and more precise in positioning and alignment, simplifying the corresponding structure and achieving the goal of cost reduction and improved production efficiency. The manufacturing methods and processes for corresponding circuit layouts on the film are based on existing mature technologies, hence they are not detailed here and are not specifically claimed for protection.

Referring to FIGS. 4 to 8, in one embodiment, at least one guide rib (7a) is set near the edge of each of the four sides of every hole (7b) on the lower surface of the top shell (7); and a corresponding number of guide grooves (8a) are created on corresponding positions of corresponding side edges of the corresponding keys (8), further ensuring smooth single direction movement and a good tactile feel when the keys (8) are pressed.

One or more embodiments of the disclosure may operate on the following working principle:

As shown in FIGS. 4 to 6, the guide ribs (7a) and the guide grooves (8a) provide directional guidance for the movement of the keys (8). Specifically, the top shell (7) is equipped with guide ribs (7a), and the edges of the keys (8) have guide grooves (8a) for precise guidance, thereby preventing lateral wobble of the keys (8) to enhance the tactile feel during pressing the keys (8);

As depicted in FIGS. 7 and 8, there is no longer a need for or a requirement that the elastic component (9) include pressing protrusions. Instead, the film's pressing protrusions (8b) are positioned on the non-elastic underside (e.g., bottom surface 8c) of the keys (8). In some embodiments, since the protrusions (8b) are formed from the same material as the material used to form the keys (8) the protrusions (8b), or another rigid material (e.g., plastic, ceramic or metal), the protrusions (8b) have almost no elasticity or compression when the film switch is actuated, further increasing the stability of the travel of the keys (8).

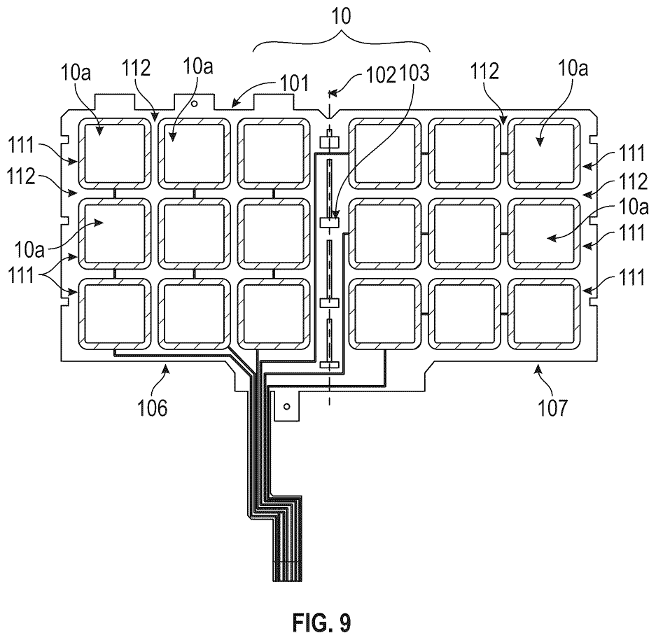

The three-layer PET film switch in existing detection modules has been redesigned into a single-layer structure. By folding this layer and adding a double-sided tape in areas (e.g., gaps 112) disposed between the folded layer, the same switch functionality is achieved, thereby simplifying the structure and avoiding problems of the prior art of the cumbersome and difficult process of aligning and bonding multiple layers of film layer-by-layer. The precise positioning can be completed simply by folding along the folding line, followed by the application of a single layer of adhesive therebetween. This greatly simplifies the structure and process of the film switch production and assembly, aiding in cost reduction and improving production efficiency, as shown in FIG. 9.

It should be noted that, in the description of this application, unless otherwise specified and defined, terms such as “installation,” “connection,” and “linking” should be understood in a broad sense, which can be mechanical or electrical connections, or internal communication between two components, and may be direct connection. Terms like “up,” “down,” “left,” “right” are used only to describe relative spatial relationships, which may change if the absolute position of a described object changes.

Secondly, in the drawings of the disclosed embodiments, only structures related to these disclosed embodiments are involved. Other structures can be referred to conventional designs. Provided there is no conflict, the same embodiment or different embodiments can be combined with each other.

Finally, the above descriptions are merely preferred embodiments. The scope of protection of various embodiments of the disclosure are not limited to the above-mentioned embodiments. Any technical solution that falls under the concept of the disclosure provided herein is within its scope of protection.

It should be noted that, for those skilled in the relevant technical fields, various improvements and refinements made without departing from the principles of the disclosure provided herein should also be encompassed within the scope of protection.

While the foregoing is directed to embodiments of the present disclosure, other and further embodiments of the disclosure may be devised without departing from the basic scope thereof, and the scope thereof is determined by the claims that follow.

What is claimed is:

1. A key structure, comprising:
a top shell comprising a plurality of holes and a plurality of guide ribs, wherein one or more guide ribs are positioned at two or more edges of each of the holes;
a plurality of keys, wherein each of the keys comprise:
a key body;
one or more protrusions extending from a surface of the key body; and
a plurality of guide grooves formed in the key body;
a detection module comprising a plurality of conductive contact structures; and
a display module,
wherein
the detection module is disposed between the display module and the plurality of keys,
a key of the plurality of keys is positioned within each of the holes of the top shell,
each key is positioned over a conductive contact structure of the detection module,
the one or more protrusions of each key is positioned over a corresponding conductive contact structure, and
each guide rib is disposed within a corresponding guide groove of each key of the plurality of keys.

2. The key structure according to claim 1, wherein the one or more protrusions and the key body comprise different materials.

3. The key structure according to claim 1, wherein the one or more protrusions and the key body comprise the same material.

4. The key structure according to claim 3, wherein the material comprises a translucent material.

5. The key structure according to claim 1, wherein
the detection module further comprises a plurality of openings, and
the key body of each of the keys is disposed over a corresponding opening of the plurality of openings.

6. The key structure according to claim 1, further comprising an elastic component that is disposed between the detection module and the plurality of keys.

7. The key structure according to claim 6, wherein
the elastic component further comprises a plurality of component openings,
the detection module further comprises a plurality of module openings, and
the key body of each of the keys is disposed over a corresponding component opening and a corresponding module opening.

8. The key structure according to claim 1, wherein
the detection module comprises a single-layer thin film having a surface on which the plurality of conductive contact structures are disposed,
the plurality of conductive contact structures comprise a plurality of first conductive contact structures positioned on a first part of the single-layer thin film and a plurality of second conductive contact structures positioned on a second part of the single-layer thin film, and
the single-layer thin film is folded over so that each of the first conductive contact structures is disposed over a corresponding second conductive contact structure.

9. The key structure according to claim 8, wherein a material layer is disposed between the first part and the second part.

10. The key structure according to claim 9, wherein the material layer comprises double-sided tape.

11. A key structure, comprising:
a top shell comprising a plurality of holes and a plurality of guide grooves, wherein one or more guide grooves are positioned at two or more edges of each of the holes;
a plurality of keys, wherein each of the keys comprise:
a key body;
one or more protrusions extending from a surface of the key body; and
a plurality of guide ribs formed in the key body;
a detection module comprising a plurality of conductive contact structures; and
a display module,
wherein
the detection module is disposed between the display module and the plurality of keys,
a key of the plurality of keys is positioned within each of the holes of the top shell,
each key is positioned over a conductive contact structure of the detection module,
the one or more protrusions of each key is positioned over a corresponding conductive contact structure, and
each guide rib of the key body of each key is disposed within a corresponding guide groove.

12. The key structure according to claim 11, wherein the one or more protrusions and the key body comprise different materials.

13. The key structure according to claim 11, wherein the one or more protrusions and the key body comprise the same material.

14. The key structure according to claim 13, wherein the material comprises a translucent material.

15. The key structure according to claim 11, wherein
the detection module further comprises a plurality of openings, and
the key body of each of the keys is disposed over a corresponding opening of the plurality of openings.

16. The key structure according to claim 11, further comprising an elastic component that is disposed between the detection module and the plurality of keys.

17. The key structure according to claim 16, wherein
the elastic component further comprises a plurality of component openings,
the detection module further comprises a plurality of module openings, and
the key body of each of the keys is disposed over a corresponding component opening and a corresponding module opening.

18. The key structure according to claim 11, wherein
the detection module comprises a single-layer thin film having a surface on which the plurality of conductive contact structures are disposed,
the plurality of conductive contact structures comprise a plurality of first conductive contact structures positioned on a first part of the single-layer thin film and a plurality of second conductive contact structures positioned on a second part of the single-layer thin film, and
the single-layer thin film is folded over so that each of the first conductive contact structures is disposed over a corresponding second conductive contact structure.

19. The key structure according to claim 18, wherein a material layer is disposed between the first part and the second part.

20. The key structure according to claim 19, wherein the material layer comprises double-sided tape.
